(19) United States
(12) Patent Application Publication
(10) Pub. No.: US 2011/0033581 A1
(43) Pub. Date: Feb. 10, 2011

(54) CRAB LEG/CRAB CLAW-LIKE FISH PASTE PRODUCT AND METHOD FOR PRODUCING THE SAME

(76) Inventor: Shigeo Yasuno, Nagano (JP)

Correspondence Address: SCHMEISER, OLSEN & WATTS, 22 CENTURY HILL DRIVE, SUITE 302, LATHAM, NY, 12110, US

(21) Appl. No.: 12/683,797

(22) Filed: Jan. 7, 2010

(30) Foreign Application Priority Data
Aug. 5, 2009 (JP) 2009-182343

(51) Int. Cl. A23L 1/325; A22C 25/00; A23L 1/27; A23P 1/00

(52) U.S. Cl. 426/92; 426/513; 426/250; 426/272

(57) ABSTRACT

An object of the present invention is to provide a crab leg/crab claw-like fish paste product having an appearance and texture similar to the shelled leg of a relatively large crab such as a king crab, the shelled claw of a queen crab or the like, and preferably eaten directly, or used as the ingredient of one-pot dishes, fried or fried tempura-style, or cooked like a steak, and a method for producing the same. The method includes the steps of: providing a mold 1 where a concave recessed portion 2 having a shape corresponding to a product shape is formed; producing a fibrous core 5 from raw ground fish meat; placing the fibrous core 5 inside the concave recessed portion 2; coating the fibrous core 5 with raw ground fish meat inside the concave recessed portion 2 to form a coating 10; and steaming the fibrous core 5 on which the coating 10 has been formed with the fibrous core 5 in the concave recessed portion 2.

### BACKGROUND OF THE INVENTION

1. Field of the Invention

The present invention relates to a crab leg/crab claw-like fish paste product and a method for producing the same, and more particularly, to a fish paste product having an appearance and texture similar to the shelled leg of a king crab, the shelled claw of a queen crab or the like, preferably used as the ingredient of one-pot dishes, fried or fried tempura-style (deep-fried in batter), or cooked like a steak, and a method for producing the same.

2. Description of the Related Art

Various fish paste products made from ground fish meat and having an appearance and texture similar to crab leg meat, and various methods for producing the fish paste products have been proposed (Japanese Patent Nos. 3056686, 3345358, 3790067, and 3167698).

The aforementioned conventional fish paste products imitate crab leg meat or crab claw meat without a shell, and are mainly used as the ingredients of salads or the like. However, there has not been proposed any fish paste product imitating the shelled leg of a relatively large crab such as a king crab, or the shelled claw of a queen crab, for example, and preferably used as the ingredient of one-pot dishes, fried or fried tempura-style, or cooked like a steak.

The present invention has been made in view of the aforementioned circumstances, and it is an object of the present invention to provide a crab leg/crab claw-like fish paste product having an appearance and texture particularly similar to the shelled leg of a relatively large crab such as a king crab, the shelled claw of a queen crab or the like, and preferably eaten directly, or used as the ingredient of one-pot dishes, fried or fried tempura-style, or cooked like a steak, and a method for producing the same.

### SUMMARY OF THE INVENTION

In order to achieve the above object, the invention according to claim 1 is a crab leg/crab claw-like fish paste product molded to have a crab leg/crab claw-like appearance, including: a fibrous core produced from raw ground fish meat and employed as a portion equivalent to crab meat; and a coating formed by coating the fibrous core with raw ground fish meat and employed as a portion equivalent to a shell.

The fibrous core is an object having a feather-like shape where cut lines are formed at narrow intervals at a slant with respect to a longitudinal direction, or is formed by binding fibrous objects together, for example. The coating is preferably colored.

In order to achieve the above object, the invention according to claim 5 is a method for producing a crab leg/crab claw-like fish paste product, including the steps of: providing a mold where a concave recessed portion having a shape corresponding to a product shape is formed; producing a fibrous core from raw ground fish meat; placing the fibrous core inside the concave recessed portion; coating the fibrous core with raw ground fish meat inside the concave recessed portion to form a coating; and steaming the fibrous core on which the coating has been formed with the fibrous core in the concave recessed portion.

In one embodiment, an open-type mold is used as the mold, and the step of forming the coating on the fibrous core includes the steps of applying the raw ground fish meat to an inner surface of the concave recessed portion of the mold, and coating an exposed surface of the fibrous core that is placed inside the concave recessed portion of the mold with the raw ground fish meat.

In another embodiment, a close-type mold where an injection port communicating with outside is formed when the mold is closed is used as the mold, and the step of forming the coating on the fibrous core includes the step of injecting the raw ground fish meat from the injection port. In this case, a crab claw or an alternative thereof is preferably inserted into the injection port before or after the injection of the raw ground fish meat.

The fibrous core is an object having a feather-like shape where cut lines are formed at narrow intervals at a slant with respect to a longitudinal direction, or is formed into a bar shape or a plate shape by binding fibrous objects together, for example. The concave recessed portion preferably has a shape corresponding to that of the shell of a crab leg, a crab claw or the like. The method preferably further includes the step of coloring the coating of the fibrous core that is removed from the concave recessed portion after the steaming step.

The crab leg/crab claw-like fish paste product according to the present invention molded to have a crab leg/crab claw-like appearance, includes: the fibrous core produced from the raw ground fish meat and employed as the portion equivalent to crab meat, and the coating formed by coating the fibrous core with the raw ground fish meat and employed as the portion equivalent to a shell. Therefore, there is an advantage that the crab leg/crab claw-like fish paste product having an appearance and texture similar to the shelled leg of a relatively large crab such as a king crab, the shelled claw of a queen crab or the like, and preferably eaten directly, or used as the ingredient of one-pot dishes, fried or fried tempura-style, or cooked like a steak can be obtained.

The method for producing a crab leg/crab claw-like fish paste product according to the present invention includes the steps of: providing the mold where the concave recessed portion having the shape corresponding to the product shape is formed; producing the fibrous core from the raw ground fish meat; placing the fibrous core inside the concave recessed portion; coating the fibrous core with the raw ground fish meat inside the concave recessed portion to form the coating; and steaming the fibrous core on which the coating has been formed with the fibrous core in the concave recessed portion, and preferably further includes the step of coloring the coating of the fibrous core that is removed from the concave recessed portion after the steaming step. Therefore, there is an advantage that the method can be easily carried out, and the fish paste product having the appearance and texture similar to a real shelled crab leg or crab claw can be mass-produced corresponding to the shape of the concave recessed portion of the mold.

### BRIEF DESCRIPTION OF THE DRAWINGS

FIG. 1 is a view illustrating a first step of one embodiment of a method according to the present invention;

FIG. 2 is a view illustrating a second step of the embodiment of the method according to the present invention;

FIG. 3 is a view illustrating a third step of the embodiment of the method according to the present invention;

FIG. 4 is a view illustrating a fourth step of the embodiment of the method according to the present invention;

FIG. 5 is a view illustrating a shape example of the shelled leg of a king crab produced using the method according to the present invention;

FIG. 6 is a view illustrating a shape example of a fibrous core used in the method according to the present invention;

FIG. 7 is a view illustrating another shape example of the fibrous core used in the method according to the present invention;

FIG. 8 is a view illustrating a first step of another embodiment of the method according to the present invention;

FIG. 9 is a view illustrating a second step of the embodiment of the method according to the present invention;

FIG. 10 is a view illustrating third and fourth steps of the embodiment of the method according to the present invention; and

FIG. 11 is a view illustrating a shape example of the crab claw of a queen crab produced using the method according to the present invention.

### DETAILED DESCRIPTION OF THE PREFERRED EMBODIMENTS

Embodiments for carrying out the present invention will be described with reference to the accompanying drawings. A crab leg/crab claw-like fish paste product according to the present invention is molded to have a crab leg/crab claw-like appearance, including a fibrous core produced from raw ground fish meat and employed as a portion equivalent to crab meat, and a coating formed by coating the fibrous core with raw ground fish meat and employed as a portion equivalent to a shell.

A method for producing a crab leg/crab claw-like fish paste product according to the present invention includes the steps of: providing a mold where a concave recessed portion having a shape corresponding to a product shape is formed; producing a fibrous core from raw ground fish meat; placing the fibrous core inside the concave recessed portion; coating the fibrous core with raw ground fish meat inside the concave recessed portion to form a coating; and steaming the fibrous core on which the coating has been formed with the fibrous core in the concave recessed portion. The method preferably further includes the step of coloring the coating of the fibrous core that is removed from the concave recessed portion after the steaming step.

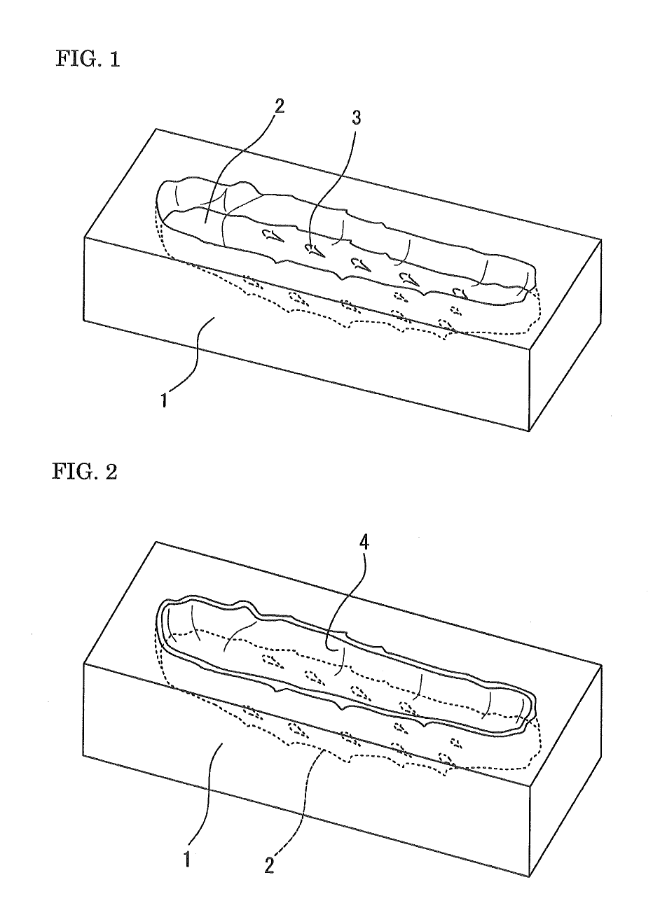

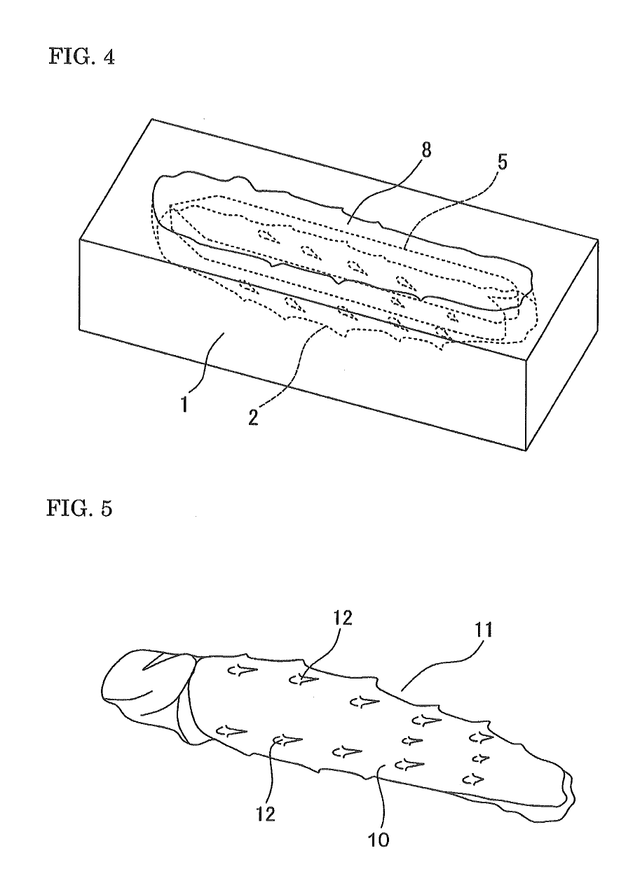

First, a first embodiment shown in FIGS. 1 to 4 will be described. In the first embodiment, a fish paste product 11 similar to the shelled leg of a king crab as shown in FIG. 5 is produced, for example. In a first step thereof, a mold 1 where a concave recessed portion 2 having the shape of a shelled crab leg to be produced is formed is provided. In this case, the mold 1 is an open type. The concave recessed portion 2 has a shape corresponding to the shape of a crab leg having a plurality of small projections 12 like the fish paste product 11 similar to the shelled leg of a king crab shown in FIG. 5, for example (FIG. 1). To form the small projections 12, small concave portions 3 are formed corresponding to the small projections 12 in the concave recessed portion 2. Although the example in which a single concave recessed portion 2 is provided in a single mold 1 is shown in the accompanying drawings, a plurality of concave recessed portions 2 are normally provided parallel to each other in a single mold 1 for mass production.

In a second step of the first embodiment, raw ground fish meat 4 is applied to the entire inner surface of the concave recessed portion 2 of the mold 1 (FIG. 2). The second step and a fourth step described below constitute the step of forming the coating. The raw ground fish meat 4 is mainly made from ground fish meat obtained by grinding fish meat such as walleye pollack with starch, salt, seasonings, egg white or the like added thereto. To allow the ground fish meat to taste like a crab, scrap meat from the shell of crabs or the like may be processed into a flake form and mixed into the ground fish meat, or the shell may be ground into a paste and mixed in the amount of about 3 to 5% into the ground fish meat. A flavor of crab, calcium or the like may be also added to the ground fish meat. Practically, frozen ground fish meat is mostly ground with salt in a grinding machine.

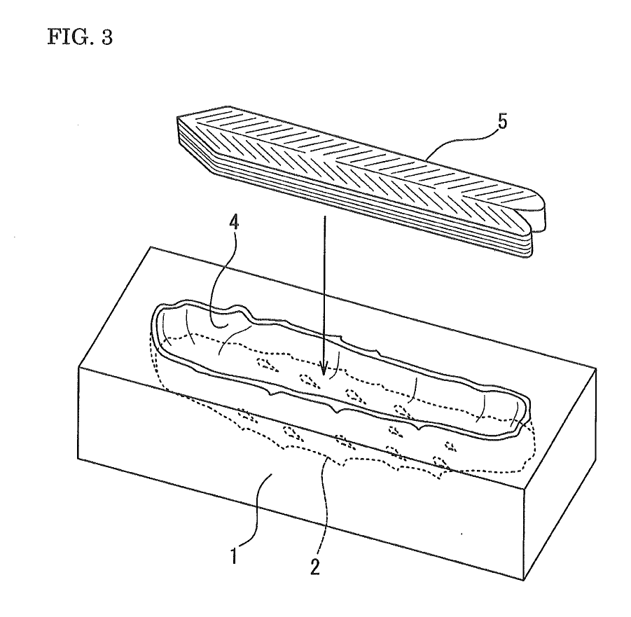

In a third step of the first embodiment, a fibrous core 5 having a size corresponding to the volume of the concave recessed portion 2 of the mold 1 is packed into the concave recessed portion 2 where the raw ground fish meat 4 is applied to the inner surface (FIG. 3). For example, an object having a feather-like shape where cut lines are formed at narrow intervals at a slant with respect to a longitudinal direction is used as the fibrous core 5.

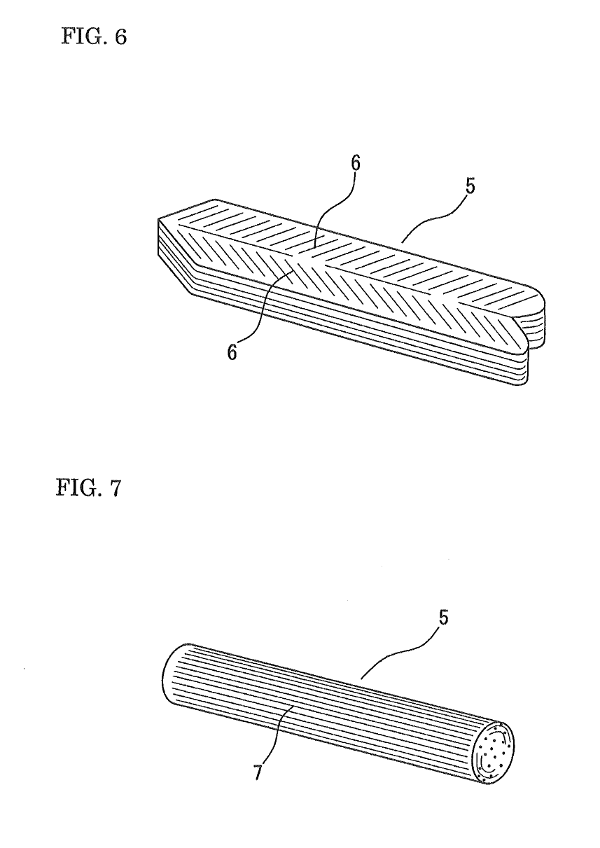

The object having a feather-like shape can be formed as follows. For example, a layered object is formed by laying the appropriate number of raw ground fish meat sheets one on top of the other and cutting the layered sheets into strips of predetermined width. Cut lines 6 are formed parallel to each other, or are formed into a symmetrical inverted V shape, at narrow intervals at a slant with respect to the longitudinal direction in the layered object. The layered object is then cut into the feather-like shape of predetermined length (FIG. 6).

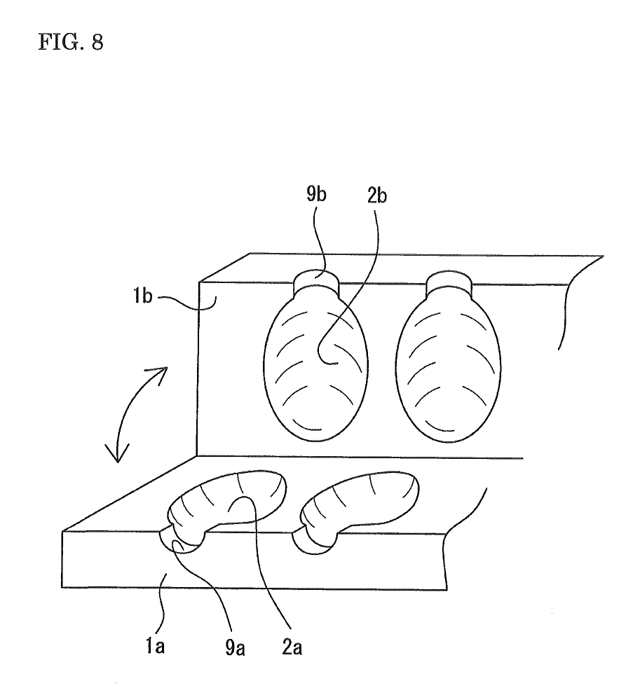

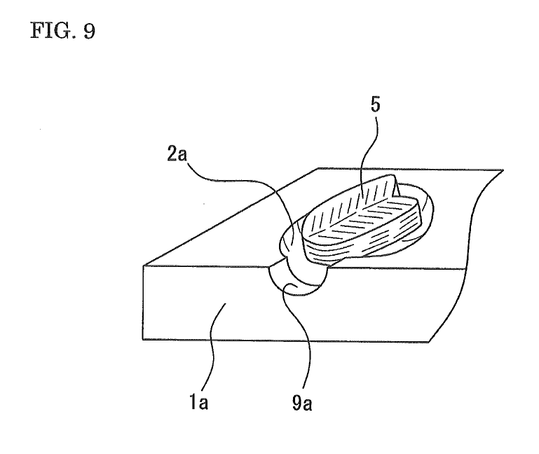

Alternatively, the object having a feather-like shape may be formed as follows. A ground fish meat sheet where cut lines 7 are formed at narrow intervals in a width direction as appropriate, is rolled into a round bar shape having an appropriate diameter (FIG. 7). Thereafter, while the rolled ground fish meat sheet is being pressed, cut lines are formed thereon at narrow intervals at a slant with respect to the longitudinal direction in a symmetrical form in a similar manner to the example shown in FIG. 6. The sheet is then cut into the feather-like shape or the like. Moreover, the fibrous core 5 may be also formed by cutting a ground fish meat sheet into fibrous strips, and binding the fibrous strips together into a bar shape or a plate shape. Other various forms may be also employed.

The fibrous cores 5 described above are equivalent to the fish paste products with cut lines disclosed in Japanese Patent Nos. 3056686, 3345358, 3790067, and 3167698. It goes without saying that other fish paste products with cut lines of various known forms can be also employed as the fibrous core 5. The fibrous core 5 is packed into the concave recessed portion 2, so that the fibrous core 5 is molded into a shape fitted to the concave recessed portion 2, that is, the shape of a shelled crab leg via the raw ground fish meat 4 that forms a coating 10 in a later step.

In a fourth step of the first embodiment, the entire exposed surface of the fibrous core 5 that is packed into the concave recessed portion 2 of the mold 1 is coated with raw ground fish meat 8. The fibrous core 5 has its entire exposed surface coated with the raw ground fish meat 8 as described above, so that the entire fibrous core 5 is covered by the coating 10 formed of the raw ground fish meat 8 and the raw ground fish meat 4 applied to the inner surface of the concave recessed portion 2. Needless to say, the coating 10 represents the appearance of the product and also prevents the fibrous core 5 from being pulled apart.

In a fifth step of the first embodiment, the fibrous core 5 on which the coating 10 of the raw ground fish meat has been formed is steamed with the fibrous core 5 in the concave recessed portion 2. When the fibrous core 5 with the coating goes through the steaming step, the fibrous core 5 with the coating is finally molded into the shape corresponding to that of the concave recessed portion 2, that is, the shape of a shelled crab leg.

In a sixth step of the first embodiment, the steamed fibrous core 5 with the coating is removed from the concave recessed portion 2. The removed fibrous core 5 with the coating may be directly employed as the crab leg-like fish paste product 11. It is, however, preferable to add a seventh step in which the coating 10 of the removed fibrous core 5 with the coating, that is, a portion equivalent to a shell is colored by using a color film or the like. Accordingly, the product having an appearance more similar to a real crab leg can be obtained.

Next, a second embodiment shown in FIGS. 8 to 10 will be described. In the second embodiment, a fish paste product similar to a shelled crab claw with a claw 13 as shown in FIG. 11 is produced. In a first step thereof, a mold 1 where a concave recessed portion 2 having the shape of a crab claw to be produced is formed is provided (FIG. 8). In this case, the mold 1 is a close type including a pair of molds 1a and 1b.

Generally, the molds 1a and 1b are symmetrical to each other. When the molds 1a and 1b are closed, concave recessed portions 2a and 2b respectively formed in the molds 1a and 1b are combined to form the single concave recessed portion 2. Semicircular grooves 9a and 9b respectively formed in the molds 1a and 1b are also combined to form an injection port 9 communicating with the outside. The semicircular groove may be formed in only one of the molds 1a and 1b.

In a second step of the second embodiment, a fibrous core 5 having a size corresponding to the volume of the concave recessed portion 2 is placed in the concave recessed portion 2a of the mold 1a in an open state (FIG. 9). The fibrous core 5 similar to that of the first embodiment can be employed.

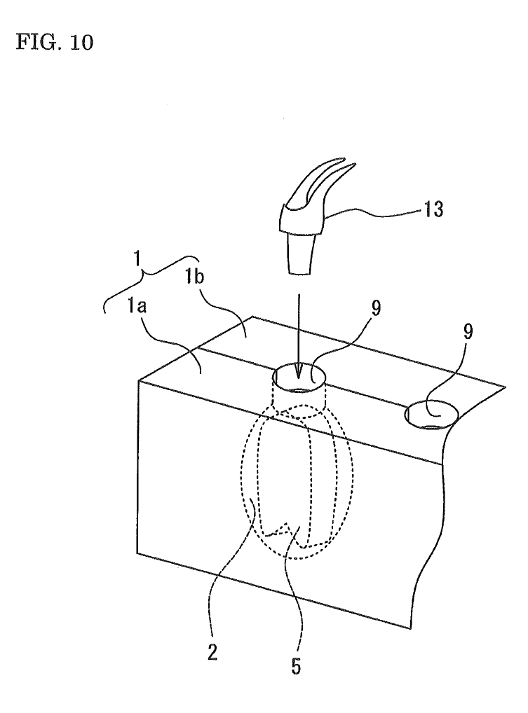

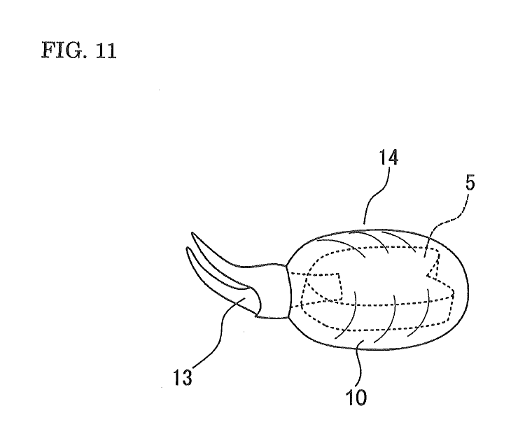

In a third step of the second embodiment, the molds 1a and 1b are closed. In the step, the concave recessed portions 2a and 2b are combined to form the single concave recessed portion 2, and the fibrous core 5 is loosely fitted in the concave recessed portion 2 (FIG. 10). Meanwhile, the semicircular grooves 9a and 9b are combined to form the injection port 9 communicating with the outside.

In a fourth step of the second embodiment, raw ground fish meat is injected from the injection port 9, to thereby form a coating 10 on the fibrous core 5. When the raw ground fish meat is injected from the injection port 9, the raw ground fish meat spreads over the fibrous core 5 that is loosely fitted in the concave recessed portion 2 to surround the fibrous core 5. The coating 10 having a shape corresponding to the shape of the concave recessed portion 2 is thereby formed. In the step, the crab claw 13 or an alternative thereof is inserted into the injection port 9 before or after the injection of the raw ground fish meat, so that a shelled crab claw 14 as shown in FIG. 11 can be obtained.

In a fifth step of the second embodiment, the fibrous core 5 on which the coating 10 of the raw ground fish meat has been formed is steamed with the fibrous core 5 in the concave recessed portion 2. When the fibrous core 5 with the coating goes through the steaming step, the fibrous core 5 with the coating is finally molded into the shape corresponding to that of the concave recessed portion 2, that is, the shelled crab claw 14.

In a sixth step of the second embodiment, the mold 1 is opened, and the steamed fibrous core 5 with the coating is removed from the concave recessed portion 2. The removed fibrous core 5 with the coating may be directly employed as the product. It is, however, preferable to add a seventh step in which the removed fibrous core 5 with the coating is appropriately colored. Accordingly, the product having an appearance more similar to a real shelled crab claw can be obtained.

The present invention has been described with reference to the most preferable embodiments thereof in detail to some extent. However, obviously, widely different embodiments can be made without departing from the spirit and scope of the present invention. The present invention should not be limited by the specific embodiments, but rather by the scope of the claims appended hereto.

What is claimed is:

1. A crab leg/crab claw-like fish paste product molded to have a crab leg/crab claw-like appearance, comprising:
a fibrous core produced from raw ground fish meat and employed as a portion equivalent to crab meat; and
a coating formed by coating the fibrous core with raw ground fish meat and employed as a portion equivalent to a shell.

2. The crab leg/crab claw-like fish paste product according to claim 1, wherein the fibrous core is an object having a feather-like shape where cut lines are formed at narrow intervals at a slant with respect to a longitudinal direction.

3. The crab leg/crab claw-like fish paste product according to claim 1, wherein the fibrous core is formed by binding fibrous objects together.

4. The crab leg/crab claw-like fish paste product according to claim 1, wherein the coating is colored.

5. A method for producing a crab leg/crab claw-like fish paste product, comprising the steps of:
providing a mold where a concave recessed portion having a shape corresponding to a product shape is formed;
producing a fibrous core from raw ground fish meat;
placing the fibrous core inside the concave recessed portion;
coating the fibrous core with raw ground fish meat inside the concave recessed portion to form a coating; and
steaming the fibrous core on which the coating has been formed with the fibrous core in the concave recessed portion.

6. The method for producing a crab leg/crab claw-like fish paste product according to claim 5, wherein an open-type mold is used as the mold, and the step of forming the coating on the fibrous core comprises the steps of applying the raw ground fish meat to an inner surface of the concave recessed portion of the mold, and coating an exposed surface of the fibrous core that is placed inside the concave recessed portion of the mold with the raw ground fish meat.

7. The method for producing a crab leg/crab claw-like fish paste product according to claim 5, wherein a close-type mold where an injection port communicating with outside is formed when the mold is closed is used as the mold, and the step of forming the coating on the fibrous core comprises the step of injecting the raw ground fish meat from the injection port.

8. The method for producing a crab leg/crab claw-like fish paste product according to claim 7, wherein a crab claw or an alternative thereof is inserted into the injection port before or after the injection of the raw ground fish meat.

9. The method for producing a crab leg/crab claw-like fish paste product according to claim 5, wherein the fibrous core is an object having a feather-like shape where cut lines are formed at narrow intervals at a slant with respect to a longitudinal direction.

10. The method for producing a crab leg/crab claw-like fish paste product according to claim 5, wherein the fibrous core is formed by binding fibrous objects together.

11. The method for producing a crab leg/crab claw-like fish paste product according to claim 5, further comprising the step of coloring the coating of the fibrous core that is removed from the concave recessed portion after the steaming step.
